(19) United States
(12) Patent Application Publication
(10) Pub. No.: US 2026/0215626 A1
(43) Pub. Date: Jul. 30, 2026

(54) MILK FROTHER HOST, HANDHELD KITCHEN STIRRING ROD, AND METHOD FOR CONTROLLING HANDHELD KITCHEN STIRRING ROD

(71) Applicant: SHENZHEN TYPHUR TECHNOLOGY CO., LTD, Shenzhen (CN)

(72) Inventors: Wei WANG, Shenzhen City (CN); Jie FENG, Shenzhen City (CN); Liang SUN, Shenzhen City (CN); Xuchao CHEN, Shenzhen City (CN)

(21) Appl. No.: 19/449,986

(22) Filed: Jan. 15, 2026

(30) Foreign Application Priority Data
Jan. 25, 2025 (CN) 202510121790.7
Jan. 25, 2025 (CN) 202520171078.3

(51) Int. Cl. A47J 43/044; A47J 43/07; A47J 43/08; A47J 43/10; G05D 13/62

(52) U.S. Cl. CPC A47J 43/044; A47J 43/0711; A47J 43/082; A47J 43/1093; G05D 13/62; A47J 2043/04427

(57) ABSTRACT

The milk frother host comprises a host housing; a drive unit defined on the host housing, the drive unit being configured to drive a stirring assembly connected to the milk frother host to rotate; a control unit configured to control a rotational speed of the drive unit, the control unit comprising an adjustment assembly; and an operating member, the operating member being defined on the host housing, the operating member changing an electrical parameter of the adjustment assembly during movement, the operating member comprising, on a movement stroke of the operating member, a first stroke segment corresponding to stopping of the drive unit and a second stroke segment corresponding to at least two non-zero rotational speeds of the drive unit; a proportion of the first stroke segment to a sum of the first stroke segment and the second stroke segment is greater than or equal to 5%.

### TECHNICAL FIELD

The present invention relates to a milk frother host, a handheld kitchen stirring rod, and a method for controlling a handheld kitchen stirring rod.

### BACKGROUND ART

A milk frother is a household appliance specifically used for making milk foam, which can stir milk into fine milk foam through rapid rotation of a milk frothing head, adding rich taste and visual effects to beverages such as coffee, latte, cappuccino, etc.

The operation of existing milk frothers often relies on switches for control. Some milk frother switches only have start-stop functions, and only one speed can be achieved after the switch is turned on. In some usage scenarios, the milk frother needs to have different rotational speeds, and some switches are set with several speed gears, each press enabling speed adjustment of one gear.

The switch operation of current milk frothers has the problem of inconvenient operation, and it is impossible to conveniently achieve different rotational speed controls.

### SUMMARY

The main technical problem solved by the present invention is the problem of inconvenient control operation of handheld kitchen stirring rods such as milk frothers.

In a first aspect, one embodiment provides a milk frother host.

A milk frother host, comprising:
a host housing for an operator to hold;
a drive unit, the drive unit being defined on the host housing, the drive unit being configured to drive a stirring assembly connected to the milk frother host to rotate;
a control unit configured to control a rotational speed of the drive unit, the control unit comprising an adjustment assembly;
and an operating member, the operating member being defined on the host housing, the operating member changing an electrical parameter of the adjustment assembly during movement, the operating member comprising, on a movement stroke of the operating member, a first stroke segment corresponding to stopping of the drive unit and a second stroke segment corresponding to at least two non-zero rotational speeds of the drive unit;
a proportion of the first stroke segment to a sum of the first stroke segment and the second stroke segment is greater than or equal to 5%.

In one embodiment, the adjustment assembly comprises an adjustment element and an adjustment portion, the adjustment portion being configured to change an electrical parameter of the adjustment element during movement; the control unit being configured to control a rotational state of the drive unit based on a change in the electrical parameter.

In one embodiment, the operating member is movably defined along a straight line on the host housing, a transmission structure being provided between the operating member and the adjustment portion, the transmission structure being configured to drive the adjustment portion to move when the operating member moves.

In one embodiment, the transmission structure comprises a movable member, the milk frother host comprising a guide seat defined inside the host housing, the movable member being movably defined along a straight line on the guide seat, with a movement direction parallel to a movement direction of the operating member; an outer peripheral surface of the movable member being provided with a clamping groove, the clamping groove having a first groove side wall and a second groove side wall spaced apart along the movement direction of the movable member, the adjustment portion being embedded in the clamping groove to reciprocate with the movable member.

In one embodiment, a side surface of the movable member is provided with a sliding groove extending along the movement direction of the movable member, the guide seat being provided with a protruding portion embedded in the sliding groove, the protruding portion being configured to restrict rotation of the movable member.

In one embodiment, the operating member is a button, the host housing having a first end and a second end, an arrangement direction of the first end and the second end being parallel to a rotational axis of the drive unit, the first end being configured to connect to the stirring assembly, the button being defined at the second end, a pressing direction of the button being parallel to the rotational axis of the drive unit.

In one embodiment, the adjustment assembly is a variable resistance element configured to produce a resistance change when the adjustment portion moves.

In a second aspect, one embodiment provides a handheld kitchen stirring rod, comprising:
a host housing for an operator to hold;
a drive unit, the drive unit being defined on the host housing, the drive unit being configured to drive a stirring assembly connected to the handheld kitchen stirring rod to rotate;
a control unit configured to control a rotational speed of the drive unit, the control unit comprising an adjustment assembly;
and an operating member, the operating member being defined on the host housing, the operating member changing an electrical parameter of the adjustment assembly during movement, the operating member comprising, on a movement stroke of the operating member, a first stroke segment corresponding to stopping of the drive unit and a second stroke segment corresponding to at least two non-zero rotational speeds of the drive unit; a proportion of the first stroke segment to a sum of the first stroke segment and the second stroke segment is greater than or equal to 5%.

In one embodiment, the stirring assembly comprises a detachable first stirring assembly and a second stirring assembly, functional units on the first stirring assembly and the second stirring assembly being different.

In a third aspect, one embodiment provides a method for controlling a handheld kitchen stirring rod:
the handheld kitchen stirring rod is provided with an operating member, the operating member being configured to change an electrical parameter of an adjustment assembly in a control unit during movement;
the control unit being configured to:
detect the electrical parameter of the adjustment assembly, and control a rotational speed of a drive unit based on a change in the electrical parameter;
when the operating member moves on a first stroke segment, the control unit detects that the electrical parameter is a first parameter value, and controls the drive unit not to rotate based on the first parameter value; and
when the operating member moves to a second stroke segment, the control unit detects that the electrical parameter is at least two second parameter values, and controls the drive unit to execute at least two non-zero rotational speeds based on the at least two second parameter values;
a proportion of the first stroke segment to a sum of the first stroke segment and the second stroke segment is greater than or equal to 5%.

One embodiment provides a handheld kitchen stirring rod host.

A handheld kitchen stirring rod host, comprising:
a host housing for an operator to hold;
an operating member defined on the host housing;
a drive unit, the drive unit being defined on the host housing, the drive unit being configured to drive a stirring assembly connected to the handheld kitchen stirring rod host to rotate;
a control unit, the control unit comprising an adjustment assembly, the operating member being connected to the adjustment assembly and configured to change an electrical parameter of the adjustment assembly, the control unit being configured to control starting and stopping of the drive unit and achieve at least two non-zero rotational speeds based on a change in the electrical parameter.

In one embodiment, the adjustment assembly comprises an adjustment element and an adjustment portion, the adjustment portion being configured to change an electrical parameter of the adjustment element during movement; the control unit being configured to control a rotational state of the drive unit based on a change in the electrical parameter.

In one embodiment, the operating member is movably defined along a straight line on the host housing, a transmission structure being provided between the operating member and the adjustment portion, the transmission structure being configured to drive the adjustment portion to move when the operating member moves.

In one embodiment, the transmission structure comprises a movable member, the handheld kitchen stirring rod host comprising a guide seat defined inside the host housing, the movable member being movably defined along a straight line on the guide seat, with a movement direction parallel to a movement direction of the operating member; an outer peripheral surface of the movable member being provided with a clamping groove, the clamping groove having a first groove side wall and a second groove side wall spaced apart along the movement direction of the movable member, the adjustment portion being embedded in the clamping groove to reciprocate with the movable member.

In one embodiment, the guide seat comprises a main body portion and a guide portion protruding from the main body portion, the guide portion being provided with a guide space for movable assembly of the movable member, one side of the guide portion being provided with a clamping interface communicating with the guide space, the clamping interface allowing the movable member to snap into the guide space and be removed from the guide space along a direction perpendicular to the movement direction of the movable member.

In one embodiment, an outer peripheral surface of the movable member is provided with two ribs extending circumferentially around the movable member, the clamping groove being formed by an interval between the ribs; the ribs being configured to abut against the guide portion along the movement direction of the movable member to prevent the movable member from escaping the guide space.

In one embodiment, the movable member is provided with a spring assembly hole, the transmission structure comprising a return spring, the return spring being configured to elastically deform when the operating member is pressed down, and drive the operating member to return when the operating member is released, the return spring being embedded in the spring assembly hole; the guide seat having an end surface spaced apart from the guide portion along the movement direction of the movable member, one end of the return spring away from the movable member abutting against the end surface.

In one embodiment, a side surface of the movable member is provided with a sliding groove extending along the movement direction of the movable member, the guide seat being provided with a protruding portion embedded in the sliding groove, the protruding portion being configured to restrict rotation of the movable member.

In one embodiment, the operating member is a button, the host housing having a first end and a second end, an arrangement direction of the first end and the second end being parallel to a rotational axis of the drive unit, the first end being configured to connect to the stirring assembly, the button being defined at the second end, a pressing direction of the button being parallel to the rotational axis of the drive unit.

In one embodiment, the operating member changes an electrical parameter of the adjustment assembly during movement, the operating member comprising, on a movement stroke of the operating member, a first stroke segment corresponding to stopping of the drive unit and a second stroke segment corresponding to at least two non-zero rotational speeds of the drive unit; a proportion of the first stroke segment to a sum of the first stroke segment and the second stroke segment is greater than or equal to 5%.

### Beneficial Effects of the Invention

According to the above handheld kitchen stirring rod host, the control unit comprises an adjustment assembly, and the operating member is capable of changing an electrical parameter of the adjustment assembly, providing conditions for the control unit to control the drive unit to achieve starting and stopping and at least two non-zero rotational speeds based on a change in the electrical parameter, which is conducive to intuitively and conveniently controlling starting and stopping of the drive unit and achieving corresponding rotational speeds.

According to the above milk frother host and handheld kitchen stirring rod, the control unit comprises an adjustment assembly, the operating member being capable of changing an electrical parameter of the adjustment assembly during movement, providing conditions for the control unit to control starting and stopping of the drive unit and achieve at least two non-zero rotational speeds based on a change in the electrical parameter, and the operating member comprising, on a movement stroke of the operating member, a first stroke segment corresponding to stopping of the drive unit and a second stroke segment corresponding to at least two non-zero rotational speeds of the drive unit; by moving the adjustment element to different positions, starting and stopping of the drive unit can be controlled and corresponding rotational speeds can be achieved, with intuitive and convenient operation, and the proportion of the first stroke segment to the sum of the first stroke segment and the second stroke segment being greater than or equal to 5%, which can avoid accidental rotation of the drive unit due to mis-touch, conducive to ensuring safety and reliability in use; at the same time, it can also provide sufficient variable gear adjustment distance for the second stroke segment.

### BRIEF DESCRIPTION OF THE DRAWINGS

FIG. 1 is a schematic structural diagram of one embodiment of the milk frother in the present invention;

FIG. 2 is an exploded view of the structure in FIG. 1;

FIG. 3 is a cross-sectional view of the milk frother in FIG. 1;

FIG. 4 is a partial enlarged view at A in FIG. 3;

FIG. 5 is an exploded view of the structure at the button portion in FIG. 1;

FIG. 6 is a schematic diagram of the transmission structure between the movable member and the adjustment element;

FIG. 7 is a schematic structural diagram of the guide seat;

FIG. 8 is a perspective view of the movable member in the transmission structure;

FIG. 9 is an exploded view of the structure at the button portion in FIG. 1 from another perspective;

FIG. 10 is a partial enlarged view at B in FIG. 3;

FIG. 11 is a schematic diagram of the assembly structure of the quick-release joint and the stirring assembly in FIG. 10;

FIG. 12 is an exploded view of the structure at the end of the stirring assembly connected to the quick-release joint;

FIG. 13 is a schematic diagram of the operating principle of the milk frother;

FIG. 14 is a schematic structural diagram of the control unit;

FIG. 15 is a schematic structural diagram of one embodiment of the control unit;

FIG. 16 is a schematic structural diagram of a feedback circuit in one embodiment.

List of reference numerals corresponding to features in the drawings:
100, milk frother host;
101, host housing; 111, first housing; 1111, ring portion; 1112, guide protrusion; 112, second housing; 113, battery compartment cover;
114, internal bracket; 1141, guide seat; 1142, main body portion; 1143, guide portion; 1144, clamping interface; 1145, protruding portion; 1146, spring support surface;
102, operating member; 121, guide recess; 122, annular flange; 123, pressing end surface; 124, insertion post;
103, drive unit; 131, output end;
104, control unit; 141, adjustment assembly; 142, adjustment portion; 143, drive module;
105, battery assembly;
106, movable member; 161, sliding groove; 162, clamping groove; 163, rib; 164, partial protrusion; 165, limiting flange; 166, spring assembly hole; 167, insertion hole;
107, return spring;
108, quick-release joint; 181, central column; 182, clamping cantilever; 183, clamping protrusion;
200, stirring assembly; 201, stirring rod; 211, anti-rotation sleeve; 212, anti-rotation protrusion; 202, adapter joint; 221, clamping groove; 203, functional unit.

### DETAILED DESCRIPTION

The present invention is further described in detail below through specific embodiments in conjunction with the accompanying drawings. Similar elements in different embodiments are assigned associated similar element numbers. In the following embodiments, many detailed descriptions are provided to enable a better understanding of the present application. However, those skilled in the art can readily recognize that some features may be omitted in different situations, or may be replaced by other elements, materials, or methods. In some cases, some operations related to the present application are not shown or described in the specification, which is to avoid overwhelming the core part of the present application with excessive descriptions, and for those skilled in the art, detailed description of these related operations is not necessary, as they can fully understand the related operations based on the description in the specification and general technical knowledge in the art.

In addition, the features, operations, or characteristics described in the specification may be combined in any appropriate manner to form various embodiments. At the same time, the steps or actions in the method description may also be exchanged or adjusted in sequence in a manner apparent to those skilled in the art. Therefore, the various sequences in the specification and drawings are only for clearly describing a certain embodiment and do not imply a necessary sequence unless otherwise specified that a certain sequence must be followed.

The numbering of units herein, such as “first,” “second,” etc., is only used to distinguish the described objects and does not have any sequential or technical meaning. The terms “connection” and “coupling” in the present application, unless otherwise specified, include both direct and indirect connections (couplings).

In the embodiments of the present invention, the control unit comprises an adjustment assembly, the operating member being capable of changing an electrical parameter of the adjustment assembly during movement, and the control unit being capable of controlling the drive unit to achieve start-stop control and speed adjustment based on changes in the electrical parameter of the adjustment element, enabling intuitive change of the rotational state of the drive unit through the operating member, which is conducive to more conveniently achieving rotational control of the stirring assembly, and the proportion of the first stroke segment of the operating member to the sum of the first stroke segment and the second stroke segment being greater than or equal to 5%, which can avoid accidental rotation of the drive unit due to mis-touch.

### Embodiments of the Handheld Kitchen Stirring Rod

In some embodiments, the handheld kitchen stirring rod may be a milk frother, please refer to FIGS. 1, 2, and 3, the milk frother comprising a milk frother host 100 and a stirring assembly 200, the milk frother host 100 comprising a host housing 101, an operating member 102, a drive unit 103, and a control unit 104. The operator can achieve start-stop control and speed control of the drive unit 103 by simply operating the operating member 102, thereby driving the stirring assembly 200 to achieve different rotational speeds, conveniently meeting different operational needs. It should be noted that those skilled in the art can understand that in some other embodiments, the handheld kitchen stirring rod may also be a device other than a milk frother, such as an egg beater, an electric cleaning brush, etc.

The technical solutions adopted in the present application will be described below in conjunction with specific embodiments.

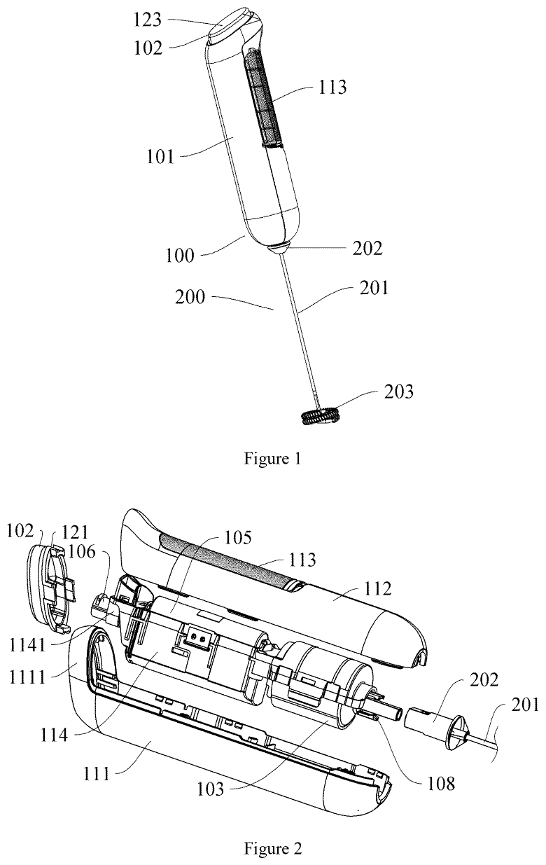

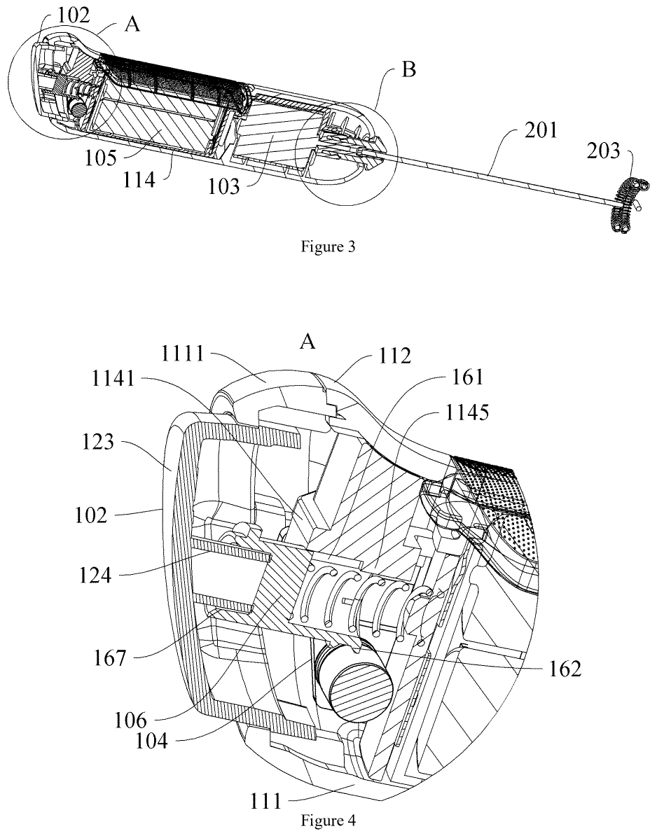

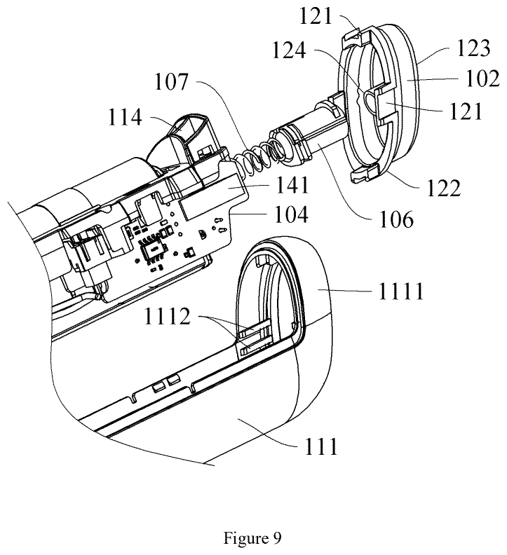

The host housing 101 can be held by an operator, and its specific structural form is not limited. For example, in some embodiments, please refer to FIGS. 2 and 3, the host housing 101 may comprise a first housing 111 and a second housing 112, both the first housing 111 and the second housing 112 may be provided with cavities, and the first housing 111 and the second housing 112 are buckled together to form an installation cavity, with the drive unit 103 and the control unit 104 (as shown in FIGS. 6 and 9) defined in the installation cavity formed by buckling the first housing 111 and the second housing 112. Those skilled in the art can understand that in some other embodiments, the host housing 101 may also be replaced by other structural forms, for example, the host housing 101 may be a cylindrical body open at one end; for another example, the host housing 101 may be jointly enclosed by three or more housing parts.

Please refer to FIG. 1, the host housing 101 may be substantially rod-shaped, having a first end and a second end, with an arrangement direction of the first end and the second end parallel to a rotational axis of the drive unit 103, the first end being configured to connect to the stirring assembly 200.

In some embodiments, to achieve power supply to the drive unit 103 and the control unit 104, the milk frother host 100 may comprise a battery assembly 105, and the second housing 112 may comprise a battery compartment cover 113, the battery compartment cover 113 being configured to cover the battery assembly 105 inside the host housing 101. Of course, the milk frother host 100 may also use an external power cord for power supply, or may use rechargeable batteries, in which case the battery compartment cover 113 may not need to be provided.

The drive unit 103 of the milk frother host 100 may be an electric motor, and those skilled in the art can understand that the electric motor may be provided with an output shaft as an output end 131 of the drive unit 103, thereby for connection to the stirring assembly 200. At the same time, the electric motor is connected to the control unit 104, and the electric motor can achieve different rotational speeds under the control of the control unit 104, thereby driving the stirring assembly 200 connected to the milk frother host 100 to rotate at the required rotational speed. Of course, the drive unit 103 has a control input end, and the control input end is connected to the control unit 104 for receiving a drive signal.

To achieve installation of the drive unit 103, in some embodiments, the host housing 101 may comprise an internal bracket 114, the drive unit 103 and the control unit 104 may both be fixed on the internal bracket 114, and the internal bracket 114 is fixedly connected to an outer shell portion of the host housing 101. By providing the above internal bracket 114, the drive unit 103 and the control unit 104 can be installed as an integral module and then assembled into the outer shell portion as a whole, facilitating assembly. Of course, in some other embodiments, the internal bracket 114 may also be integrally formed with the outer shell portion, or positioning and fixing structures may be directly provided on the outer shell portion to fixedly connect the drive unit 103 and the control unit 104 to the outer shell portion of the host housing 101.

The control unit 104 is configured to output a drive signal to the drive unit 103, causing the drive unit 103 to respond to the drive signal and perform movement. The control unit 104 may be a circuit board assembly, comprising a circuit board and electronic components, capable of forming a drive circuit, the drive circuit may comprise an adjustment assembly 141 and a drive module 143, the adjustment element being configured to output a resistance value signal to the drive module 143, the drive module 143 being configured to control the action of the drive unit 103. The adjustment assembly 141 may comprise an adjustment element (not shown in the figure) and a movable adjustment portion 142, the adjustment portion 142 being configured to change an electrical parameter (e.g., resistance value) of the adjustment element during movement, and the drive module 143 being capable of controlling the drive unit 103 to start and stop and achieve at least two non-zero rotational speeds based on changes in the electrical parameter, with different rotational speeds corresponding to different movement positions of the adjustment portion 142.

It should be noted that the adjustment assembly 141 may employ any electrical component capable of achieving the drive unit control effect, for example, it may be a variable resistor, or a potentiometer, or a Hall sensor, an infrared sensor, etc. When the adjustment assembly 141 employs sensors such as a Hall sensor or an infrared sensor, it can change the electrical parameter by sensing the stroke of the operating member, thereby achieving the effect of adjusting the rotational speed.

In addition, in some embodiments, the adjustment assembly 141 may also sense pressure magnitude through a pressure sensor. For example, the adjustment assembly 141 may be a pressure sensor, which senses the pressing pressure of the operating member 102 through the pressure sensor, thereby changing the electrical parameter corresponding to the pressure, with greater pressure corresponding to higher rotational speed; for another example, the adjustment assembly 141 may change the electrical parameter by sensing the duration of continuous pressing, with longer pressing time corresponding to higher rotational speed.

The control unit 104 may be fixed on the internal bracket 114 or on the outer shell portion. In one specific embodiment, please refer to FIG. 9, the control unit 104 may be fixed on a side surface of the internal bracket 114, with the fixing method not limited, such as snap fixing, adhesive fixing, fastener fixing, etc.

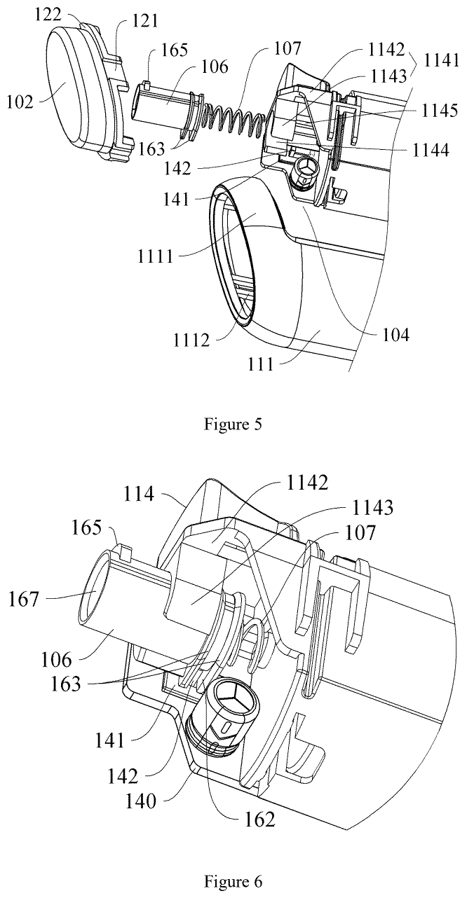

In some embodiments, the adjustment assembly 141 may be a variable resistance element, and the adjustment portion 142 may be a toggle protruding from the main body of the adjustment assembly 141, the adjustment assembly 141 being capable of producing a resistance change when the adjustment portion 142 moves linearly. Exemplarily, the variable resistance element may be a sliding rheostat. Please refer to FIG. 5, where a dashed line is used to indicate another stroke limit of the toggle.

The adjustment portion 142 has a first stroke segment and a second stroke segment on its movement stroke, enabling start-stop control and achievement of corresponding rotational speeds by moving the adjustment element to different positions, with intuitive and convenient operation. In the first stroke segment, the control unit 104 is configured to control the drive unit 103 to start based on the corresponding electrical parameter of the adjustment assembly 141, and in the second stroke segment, the control unit 104 is configured to control the drive unit 103 to achieve different rotational speeds based on changes in the corresponding electrical parameter.

One embodiment using a variable resistance element will be specifically described below.

The variable resistance element has a resistance value output end, the resistance value output end being configured to output a resistance value signal corresponding to the current resistance value of the variable resistance element. The drive module 143 is configured to generate a corresponding drive signal based on the resistance value signal. The drive module 143 has a control end and a drive output end, the control end of the drive module 143 being connected to the resistance value output end of the variable resistance element for receiving the resistance value signal, and the drive output end of the drive module 143 being connected to the control input end of the drive unit 103 for outputting the drive signal to the drive unit 103.

In some embodiments, the resistance value of the variable resistance element can continuously change within a first range of resistance values, each resistance value in the first range of resistance values having a corresponding first resistance value signal. In some embodiments, the resistance value of the variable resistance element can be discrete continuous change or non-discrete continuous change within the first range of resistance values, for example, discrete continuous change of 1Ω, 2Ω, 3Ω, 4Ω, 5Ω within the range of 1-5Ω, or non-discrete continuous change of any resistance value within 1-5Ω. In some embodiments, the first resistance value signals corresponding to each resistance value in the first range of resistance values are different, that is, the first resistance value signal has a one-to-one correspondence with the resistance value. In some embodiments, the first resistance value signal may be a voltage signal or a current signal in one-to-one correspondence with the resistance value.

In some embodiments, the resistance value of the variable resistance element can also be in a second range of resistance values, each resistance value in the second range of resistance values having a corresponding second resistance value signal. In some embodiments, the resistance value of the variable resistance element can continuously change within the second range of resistance values, for example, discrete continuous change or non-discrete continuous change within the second range of resistance values, which will not be repeated here. In some embodiments, the second range of resistance values is different from the first range of resistance values but may be continuous, for example, the first range of resistance values is 1-5Ω, including the endpoint 5Ω, and the second range of resistance values is 5-10Ω, excluding the endpoint 5Ω. In some embodiments, the second resistance value signals corresponding to each resistance value in the second range of resistance values are different, that is, the second resistance value signal has a one-to-one correspondence with the resistance value. In some embodiments, the second resistance value signal may be a voltage signal or a current signal in one-to-one correspondence with the resistance value.

In some embodiments, the resistance value of the variable resistance element can also be in a third range of resistance values, each resistance value in the third range of resistance values having a corresponding third resistance value signal. In some embodiments, the resistance value of the variable resistance element can continuously change within the third range of resistance values, for example, discrete continuous change or non-discrete continuous change within the third range of resistance values, which will not be repeated here. In some embodiments, the third range of resistance values is different from the first range of resistance values and the second range of resistance values but may be continuous, which will not be repeated here. In some embodiments, the third range of resistance values may also be the same as the second range of resistance values. In some embodiments, the third resistance value signals corresponding to each resistance value in the third range of resistance values are different, that is, the third resistance value signal has a one-to-one correspondence with the resistance value. In some embodiments, the third resistance value signal may be a voltage signal or a current signal in one-to-one correspondence with the resistance value.

The operating member 102 can move and drive the adjustment portion 142 to move, for example, a user can operate the operating member 102 to cause the operating member 102 to move, thereby driving the adjustment portion 142 to move. The specific structure of the operating member 102 may be the button described below. It should be noted that in some other embodiments, the operating member 102 may also be replaced by other structural forms, such as a rotatable lever.

The resistance value of the variable resistance element corresponds to the position of the adjustment portion 142, for example, each position of the adjustment portion 142 causes the variable resistance element to be at a corresponding resistance value. The adjustment portion 142 can continuously move within a first range of positions, causing the resistance value of the variable resistance element to continuously change correspondingly within the first range of resistance values. In some embodiments, the adjustment portion 142 can also continuously move within a second range of positions, causing the resistance value of the variable resistance element to continuously change correspondingly within the second range of resistance values, and continuously move within a third range of positions, causing the resistance value of the variable resistance element to continuously change correspondingly within the third range of resistance values, the second range of positions is different from the first range of positions but may be continuous, and the third range of positions may be different from the first range of positions and the second range of positions but may be continuous, or may be the same as the second range of positions, which will not be repeated here.

In some embodiments, the movement of the operating member 102 may be consistent with the movement of the adjustment portion 142, for example, the movement mode of the operating member 102 may be linear reciprocating motion, causing the movement mode of the adjustment portion 142 to also be linear reciprocating motion, with different positions on the straight line corresponding to different resistance values. For example, the movement mode of the operating member 102 may be rotational motion, causing the movement mode of the adjustment portion 142 to also be rotational motion, with different rotation angles corresponding to different resistance

values. In some embodiments, the movement modes of the operating member 102 and the adjustment portion 142 may also be other modes of movement, which may be consistent or inconsistent, for example, when the operating member 102 is in rotational motion, it can cause the movement mode of the adjustment portion 142 to be linear reciprocating motion based on a transmission member, which will not be repeated here. In some embodiments, the operating member 102 may be configured accordingly based on its movement mode, for example, when the movement mode of the operating member 102 is rotational motion, it may be a knob button, for example, when the movement mode of the operating member 102 is linear reciprocating motion, it may be a sliding button, which will not be repeated here.

In some embodiments, the adjustment portion 142 may continuously move, corresponding to non-discrete continuous change in the resistance value of the variable resistance element, and in some embodiments, the adjustment portion 142 may also be staged sliding, corresponding to discrete continuous change in the resistance value of the variable resistance element, for example, based on a limiting structure causing the adjustment portion 142 to directly slide to endpoints of the first range of positions, the second range of positions, or the third range of positions during sliding, thereby achieving staged sliding.

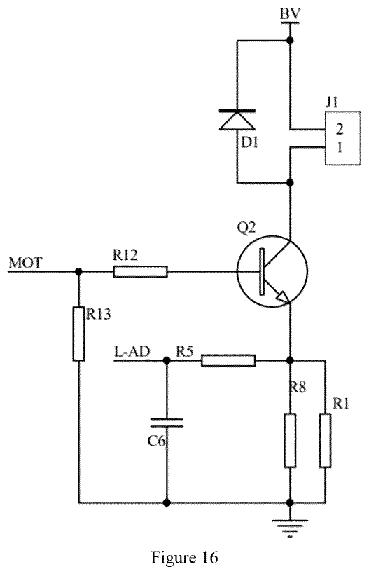

Please refer to FIG. 15, in some embodiments, the variable resistance element comprises a sliding converter RV, the sliding converter RV having a resistance adjustment end (not shown), a first end (end 1 of the sliding converter RV), a second end (end 3 of the sliding converter RV), and a sliding output end (end 2 of the sliding converter RV), the first end of the sliding converter RV is configured to connect to a power supply, the second end of the sliding converter RV is configured to ground or connect to an output end of a controller (please refer to FIGS. 15 and 16, in some embodiments, the drive module 143 may comprise a controller U3 and a switching device Q2), the sliding output end of the sliding converter RV is connected to the output end of the controller, and when the adjustment portion 142 of the sliding converter RV moves, the resistance value of the sliding converter RV changes, and the sliding output end of the sliding converter RV outputs a voltage signal corresponding to the resistance value. In some embodiments, the sliding converter RV may also be connected in series or parallel with other resistors to adjust the voltage signal output by the sliding output end. In some embodiments, when the second end of the sliding converter RV is connected to the controller, the controller can cause the output end to cut off or conduct to adjust the resistance value signal output by the sliding converter RV, for example, when the output ends connected to the second end and the sliding output end of the sliding converter RV are cut off, the sliding converter RV stops outputting the resistance value signal to reduce the power consumption of the sliding converter RV.

In some embodiments, corresponding to the second stroke segment of the adjustment portion 142, the drive module 143 is configured to generate a corresponding first drive signal based on the first resistance value signal for driving an output end 131 of the drive unit 103 to move at a corresponding speed. Each first resistance value signal has a corresponding first drive signal, and different first drive signals are configured to drive the output end 131 of the drive unit 103 to move at different speeds. In some embodiments, multiple first resistance value signals may correspond to one first drive signal, or each first resistance value signal may correspond to one first drive signal. In some embodiments, the first drive signal may be a PWM signal, with different PWM signal duty cycles between different first drive signals, thereby driving the output end 131 of the drive unit 103 to move at different speeds. In some embodiments, when the drive unit 103 comprises an electric motor, different first drive signals are configured to drive the output end 131 of the drive unit 103 to perform rotational motion at different rotational speeds.

In some embodiments, corresponding to the first stroke segment of the adjustment portion 142, the drive module 143 is configured to generate a corresponding second drive signal based on the second resistance value signal for driving the output end 131 of the drive unit 103 to stop moving. Each second resistance value signal may correspond to one second drive signal. In some embodiments, the second drive signal may be a high-level signal or a low-level signal, for example, the drive module 143 responds to the second drive signal and stops driving the drive unit 103, for example, the drive module 143 responds to the second drive signal and closes.

In some embodiments, the drive module 143 is configured to generate a corresponding third drive signal based on the third resistance value signal for driving the output end 131 of the drive unit 103 to start moving. Each third resistance value signal may correspond to one third drive signal, and in some embodiments, the second drive signal may be a high-level signal or a low-level signal, for example, the drive module 143 responds to the third drive signal and drives the drive unit 103 to move at an initial speed, for example, the drive module 143 responds to the third drive signal and starts.

A first end of the switching device Q2 is configured to connect to the control input end of the drive unit 103, that is, pins 1 and 2 of connector J2 are configured to connect to the positive and negative poles of the drive unit 103 respectively, the first end of the switching device Q2 is connected to pin 1 of connector J2, a second end of the switching device Q2 is configured to ground, and a control end of the switching device Q2 is configured to connect to a control end of the controller U3. In some embodiments, the switching device Q2 may comprise a transistor such as a triode or a field-effect transistor having a switching function.

The control end of the controller U3 is configured to output a first drive signal (MOT) with a duty cycle corresponding to the first drive signal or a frequency corresponding to the first drive signal to the control end of the switching device Q2,

causing the switching device Q2 to alternately conduct and cut off at the corresponding duty cycle or at the corresponding frequency, thereby causing the drive unit 103 to move at the corresponding speed. In some embodiments, the controller U3 may comprise a controller device with control functions such as a CPU, FPGA, single-chip microcomputer, etc.

Please refer to FIG. 16, in some embodiments, the drive module 143 further comprises a feedback circuit. An input end of the feedback circuit is configured to connect to the second end of the switching device Q2, an output end of the feedback circuit is connected to the controller U3, and the feedback circuit is configured to collect a voltage or current at the second end of the switching device Q2 and output a corresponding feedback signal (L-AD) to the controller U3. In some embodiments, the voltage or current at the second end of the switching device Q2 is related to the voltage or current of the drive unit 103, so the feedback signal can characterize the voltage or current of the drive unit 103, and when the feedback signal does not meet a preset condition, the controller U3 can adjust the drive signal based on the corresponding feedback signal to achieve feedback control based on the feedback circuit. In some embodiments, the feedback circuit comprises a sampling resistor R5, one end of the sampling resistor R5 being connected to the second end of the switching device Q2, and the other end of the sampling resistor R5 being connected to the controller U3.

In the above embodiments, based on the continuous change in the resistance value of the variable resistance element, the drive module 143 can generate corresponding drive signals, and different drive signals can be used to drive the drive unit 103 to move at different speeds, thereby enabling flexible adjustment of the speed of the stirring assembly 200.

In some embodiments, the adjustment assembly 141 of the control unit 104 may be controlled by the operating member 102, the operating member 102 being movably defined along a straight line on the host housing 101, a transmission structure being provided between the operating member 102 and the adjustment portion 142, the transmission structure being configured to drive the adjustment portion 142 to move when the operating member 102 moves. In some embodiments, the transmission structure may comprise a movable member 106 and a return spring 107, and the related structures will be further described below.

The pressing direction of the operating member 102 may be parallel to the rotational axis of the drive unit 103, that is, parallel to the distribution direction of the first end and the second end of the host housing 101. Correspondingly, the movement direction of the movable member 106 may be consistent with the pressing direction of the operating member 102. To enable the movable member 106 to move according to a preset path and ensure the operational stability and reliability of the milk frother, in some embodiments, the milk frother host 100 comprises a guide seat 1141 defined inside the host housing 101, the guide seat 1141 may be a part of the internal bracket 114, and the movable member 106 is movably defined along a straight line on the guide seat 1141, with the movement direction parallel to the movement direction of the operating member 102.

The structural form of the guide seat 1141 is not limited, and in one specific embodiment, please refer to FIGS. 5, 6, and 7, the guide seat 1141 may comprise a main body portion 1142 and a guide portion 1143 protruding from the main body portion 1142, the guide portion 1143 being provided with a guide space for movable assembly of the movable member 106. One side of the guide portion 1143 may be provided with a clamping interface 1144 communicating with the guide space, the clamping interface 1144 allowing the movable member 106 to snap into the guide space and be removed from the guide space along a direction perpendicular to the movement direction of the movable member 106. Providing the above clamping interface 1144 on the guide seat 1141 can conveniently achieve disassembly and assembly of the movable member 106, and can avoid interference with the movable adjustment portion 142 on the adjustment assembly 141 when disassembling and assembling the movable member 106. Movably defining the movable member 106 on the internal bracket 114 while fixing the control unit 104 on the internal bracket 114 can enable the movable member 106 to connect more accurately and stably with the adjustment assembly 141 of the control unit 104.

In some other embodiments, the guide portion 1143 may also be replaced by other forms, such as a guide hole for movable insertion of the movable member 106, or a guide track, etc.

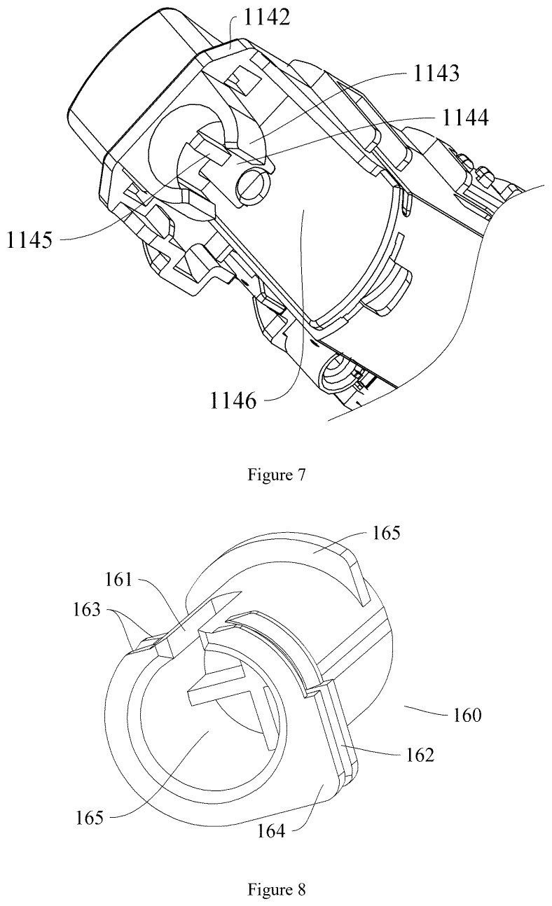

In some embodiments, a side surface of the movable member 106 is provided with a sliding groove 161 extending along the movement direction of the movable member 106 (refer to FIGS. 4 and 8), the guide seat 1141 being provided with a protruding portion 1145 embedded in the sliding groove 161 (refer to FIGS. 4 and 7), the protruding portion 1145 being configured to restrict rotation of the movable member 106. The above sliding groove 161 and protruding portion 1145 can cooperate to form an anti-rotation structure, preventing the movable member 106 from rotating, thereby maintaining a stable and reliable transmission relationship with the adjustment portion 142 on the adjustment assembly 141, and helping to avoid swinging of the movable member 106 in the guide space that affects smooth guidance of the movable member 106. Of course, in some other embodiments, the above anti-rotation structure may also be replaced by other forms, for example, an anti-rotation plane may be provided on the outer peripheral surface of the movable member 106, and an adapted plane may be provided on the inner side wall of the guide portion 1143, thereby avoiding rotation of the movable member 106 through plane cooperation.

In some embodiments, please refer to FIG. 8, the overall shape of the movable member 106 may be substantially cylindrical, an outer peripheral surface of the movable member 106 being provided with a clamping groove 162, the clamping groove 162 having a first groove side wall and a second groove side wall spaced apart along the movement direction of the movable member 106, the adjustment portion 142 being embedded in the clamping groove 162 to reciprocate with the movable member 106. When installing the movable member 106, the clamping groove 162 can be aligned with the adjustment portion 142 on the adjustment assembly 141, and then the movable member 106 can be snapped into the guide space on the guide portion 1143 along the opening direction of the clamping interface 1144 on the guide portion 1143. When the movable member 106 is installed in place in the guide space, the groove walls of the clamping groove 162 (i.e., the two ribs 163 on both sides of the clamping groove 162) can be respectively located on both sides of the adjustment portion 142.

In one specific embodiment, the outer peripheral surface of the movable member 106 is provided with two ribs 163 extending circumferentially around the

movable member 106, and the clamping groove 162 is formed by the interval between the ribs 163. The above clamping groove 162 formed by the ribs 163 can form a larger clamping area circumferentially around the movable member 106, and is conducive to improving the structural strength of the movable member 106 and ensuring the structural stability of the movable member 106. As shown in FIG. 8, the ribs 163 may comprise partial protrusions 164 provided on a side close to the adjustment assembly 141, the partial protrusions 164 being capable of forming a longer clamping size with the adjustment portion 142 on the adjustment assembly 141, conducive to more reliably driving the adjustment portion 142 to move.

In addition, the ribs 163 can abut against the guide portion 1143 along the movement direction of the movable member 106 to prevent the movable member 106 from escaping the guide space. A limiting flange 165 is protrudingly provided on the outer peripheral surface of the movable member 106 near one end of the operating member 102. After the movable member 106 is installed on the guide seat 1141, the guide portion 1143 of the guide seat 1141 is located in the interval between the limiting flange 165 of the movable member 106 and the ribs 163, and can abut against the limiting flange 165 and the ribs 163 to limit the movement stroke of the movable member 106, thereby avoiding excessive movement of the movable member 106 driven by the operating member 102 that causes the adjustment portion 142 of the adjustment assembly 141 to exceed the adjustable stroke, conducive to improving the working life and reliability of the milk frother.

An elastic return member is provided between the movable member 106 and the guide seat 1141, capable of automatically returning the movable member 106 and the operating member 102 when the operator releases the operating member 102, and driving the adjustment assembly 141 to return. In one specific embodiment, please refer to FIGS. 4, 8, and 9, an inner cavity of the cylindrical movable member 106 forms a blind hole-shaped spring assembly hole 166, the transmission structure comprises a return spring 107, the return spring 107 being configured to elastically deform when the operating member 102 is pressed down, and drive the operating member 102 to return when the operating member 102 is released, the return spring 107 being embedded in the spring assembly hole 166; the guide seat 1141 having an end surface spaced apart from the guide portion 1143 along the movement direction of the movable member 106, the end surface forming a spring support surface 1146, one end of the return spring 107 away from the movable member 106 abutting against the end surface. In some other embodiments, the elastic return member may also be replaced by other forms, such as an elastic sheet, a tension spring, etc., as long as it can achieve return of the movable member 106.

The operating member 102 is defined at one end of the host housing 101 away from the stirring assembly 200, that is, the second end of the host housing 101, with the pressing direction of the operating member 102 parallel to the rotational axis of the drive unit 103. To facilitate reliable operation of the operating member 102 by the operator, in some embodiments, the first housing 111 is provided with a guide structure, and the operating member 102 is assembled on the first housing 111 through the guide structure.

In one specific embodiment, please refer to FIGS. 4, 5, and 9, the second end of the first housing 111 is provided with a ring portion 1111, the ring portion 1111 being provided with a guide structure to guide the movement of the operating member 102. The specific form of the guide structure is not limited, for example, several guide protrusions 1112 may be provided on the inner wall of the ring portion 1111, the guide protrusions 1112 being distributed circumferentially, and several guide recesses 121 may be correspondingly provided on the outer peripheral surface of the operating member 102, the guide protrusions 1112 and the guide recesses 121 being capable of limiting the movement direction of the operating member 102 and avoiding rotation of the operating member 102. The ring portion 1111 provided on the first housing 111 can form an integral guide structure, conducive to improving guide accuracy and ensuring smooth action of the operating member 102. Those skilled in the art can understand that in some other embodiments, the first housing 111 and the second housing 112 may also jointly enclose a ring portion to guide the operating member 102, or the operating member 102 may also be defined on the internal bracket 114 of the host housing 101.

Since an elastic return member is provided between the movable member 106 and the guide seat 1141, to avoid the operating member 102 being ejected by the elastic return member, in some embodiments, an annular flange 122 is provided on the outer peripheral surface of the operating member 102, the annular flange 122 being capable of forming a stop fit with a step surface on the ring portion 1111 to avoid separation of the operating member 102 from the host housing 101.

The operating member 102 has a pressing end surface 123 for pressing by the operator, and in some embodiments, the pressing end surface 123 may be inclined relative to the movement direction of the operating member 102, more ergonomic, facilitating the operator to hold the milk frother host 100 and press the operating member 102 with the thumb.

It should be noted that in some other embodiments, the transmission structure between the operating member 102 and the adjustment element may also be replaced by other forms, as long as it can drive the adjustment portion to move when the operating member 102 moves. For example, an insertion hole may be provided on the movable member 106, with the adjustment portion directly inserted into the insertion hole; for another example, the movable member 106 and the adjustment portion may be directly fixedly connected through a fastener (such as a screw); for yet another example, the movable member 106 and the operating member 102 may be an integral structure. In addition, the transmission structure may be a mechanism formed by multiple parts, such as a lever mechanism, a link assembly, etc., the linear motion of the operating member 102 may also be converted to rotation of the adjustment portion through the transmission structure, and the rotation of the operating member 102 may also be converted to linear motion of the adjustment portion through the transmission structure.

When the size of the operating member 102 along the pressing operation direction is small, to achieve good guidance of the operating member 102, a more precise fit is required between the operating member 102 and the host housing 101. To avoid jamming of the operating member 102 and increased manufacturing costs caused thereby, please refer to FIG. 4, an insertion hole 167 may be provided on one of the operating member 102 and the movable member 106, and an insertion post 124 may be provided on the other, the insertion post 124 being inserted and fixed in the insertion hole 167, enabling the operating member 102 and the movable member 106 to support each other. It should be noted that in some other embodiments, the insertion hole 167 and the insertion post 124 may also be omitted, and the operating member 102 may also abut against the outer surface of the movable member 106.

The proportion of the first stroke segment of the operating member 102 to the sum of the first stroke segment and the second stroke segment is greater than or equal to 5%. For example, the ratio range of the first stroke of the first stroke segment to the second stroke of the second stroke segment may be 1:2 to 2:3. Taking a ratio of 1:2 for the first stroke segment and the second stroke segment as an example, when the operating member 102 moves to where the first stroke accounts for 1/3 of the sum of the first stroke and the second stroke, the control unit 104 controls the drive unit 103 to start, for example, to start rotating. In some specific embodiments, the first stroke may be greater than or equal to 2 mm, and the sum of the first stroke and the second stroke may be approximately 5 mm. It can be understood that in other embodiments, the proportion of the first stroke segment to the sum of the first stroke segment and the second stroke segment may also be 5%, 6%, 7%, 8%, 9%, 10%, 15%, 20%, 30%, etc. If the first stroke is too small, it is easy to cause mis-touch, and if it is too large, it will lead to insufficient subsequent speed adjustment stroke. The proportion of the first stroke to the sum of the first stroke and the second stroke being greater than or equal to 5% is conducive to balancing the anti-mis-touch function and sufficient speed adjustment stroke for the operating member.

The stirring assembly 200 of the milk frother is configured to act on food materials, and in some embodiments, please refer to FIGS. 1, 3, and 10, the stirring assembly 200 may comprise a stirring rod 201, and an adapter joint 202 and a functional unit 203 respectively defined at two ends of the stirring rod 201. The adapter joint 202 is configured to connect to the milk frother host 100 to rotate under the drive of the drive unit 103, and the stirring rod 201 is configured to drive the functional unit 203 to rotate, thereby achieving milk foam production. The specific structure of the functional unit 203 may refer to existing structures in related art, and since it has no direct association with the innovative content and the technical problems to be solved in the present application, it will not be repeated here. For example, one end of the stirring rod 201 away from the milk frother host 100 may be provided with a spiral bent portion, and a stirring spring may be sleeved on the spiral bent portion to form the functional unit 203 of the stirring assembly 200.

To meet different usage needs, in some embodiments, the stirring assembly 200 is a detachable assembly. At this time, the stirring assembly 200 of the milk frother comprises a detachable first stirring assembly 200 and a second stirring assembly 200, with different functional units 203 on the first stirring assembly 200 and the second stirring assembly 200, and the specific structures of these functional units 203 may refer to existing structures in related art, with the specific form not limited. For example, the first stirring assembly 200 may be a cleaning brush head for cleaning a milk foam container, while the second stirring assembly 200 may be a milk frothing head for making milk foam; for another example, the stirring spring of the first stirring assembly 200 may be a single-layer spring, while the stirring spring of the second stirring assembly 200 may be a double-layer spring. In some other embodiments, the stirring assembly 200 may also be connected to the milk frother host in a non-detachable manner, such as by bonding, welding, etc.

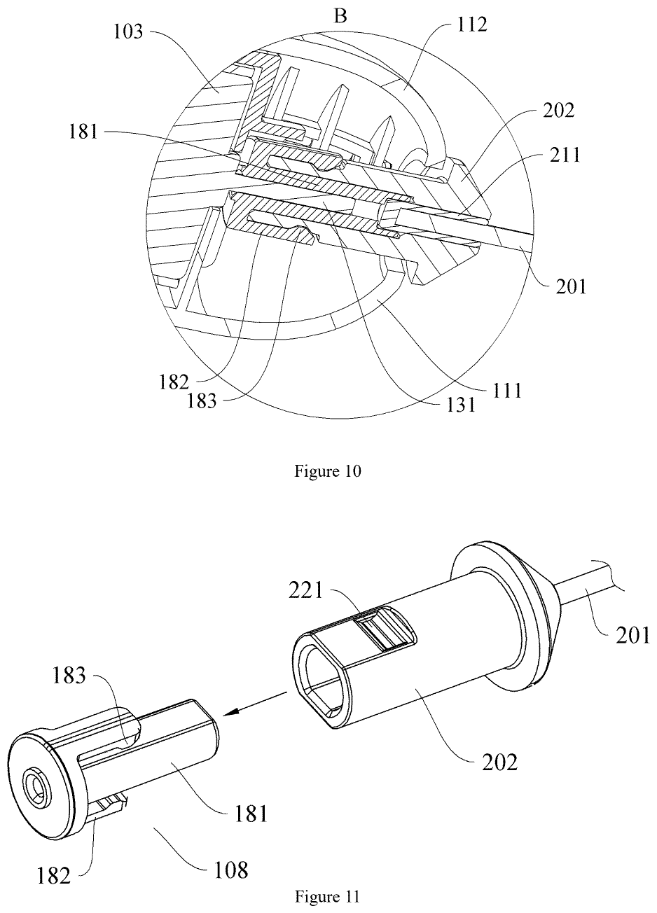

To achieve detachable installation of the stirring assembly 200, thereby enabling replacement with a new stirring assembly 200 or replacement with stirring assemblies 200 of different functions, please refer to FIGS. 10, 11, and 12, the milk frother host 100 further comprises a quick-release joint 108, the quick-release joint 108 being fixed at the output end 131 of the drive unit 103 for detachable connection of the stirring assembly 200.

In one specific embodiment, the quick-release joint 108 comprises a central column 181 and a clamping cantilever 182. The central column 181 is configured to be inserted into the adapter joint 202 at the end of the stirring assembly 200, and an outer peripheral surface of the central column 181 is provided with a torque transmission structure for transmitting torque to the stirring assembly 200. For example, the outer peripheral surface of the central column 181 may be provided with a planar structure, and the hole wall of the insertion hole 167 on the adapter joint 202 may be provided with an adapted planar structure, relying on the planar structure as the torque transmission structure. For another example, a flat key, spline, etc., may be provided between the central column 181 and the adapter joint 202 to form the torque transmission structure.

The torque transmission structure can achieve torque transmission between the quick-release joint 108 and the stirring assembly 200, and to ensure reliable connection between the quick-release joint 108 and the stirring assembly 200, in some embodiments, the clamping cantilever 182 of the quick-release joint 108 may be defined on a radial side of the central body, one end of the clamping cantilever 182 being connected to the main body portion 1142, the other end being suspended, the suspended end of the clamping cantilever 182 being provided with a clamping protrusion 183, the clamping protrusion 183 being configured to clamp into a clamping groove 221 provided on the outer peripheral surface of the adapter joint 202, capable of preventing easy separation of the quick-release joint 108 from the stirring assembly 200. The clamping cantilever 182 has elasticity, and slope surfaces may be provided on the groove walls of the clamping groove 221 and on both sides of the clamping protrusion 183 along the rotational axis of the stirring assembly 200, so that the stirring assembly 200 can be removed from the quick-release joint 108 by applying greater force to the stirring assembly 200.

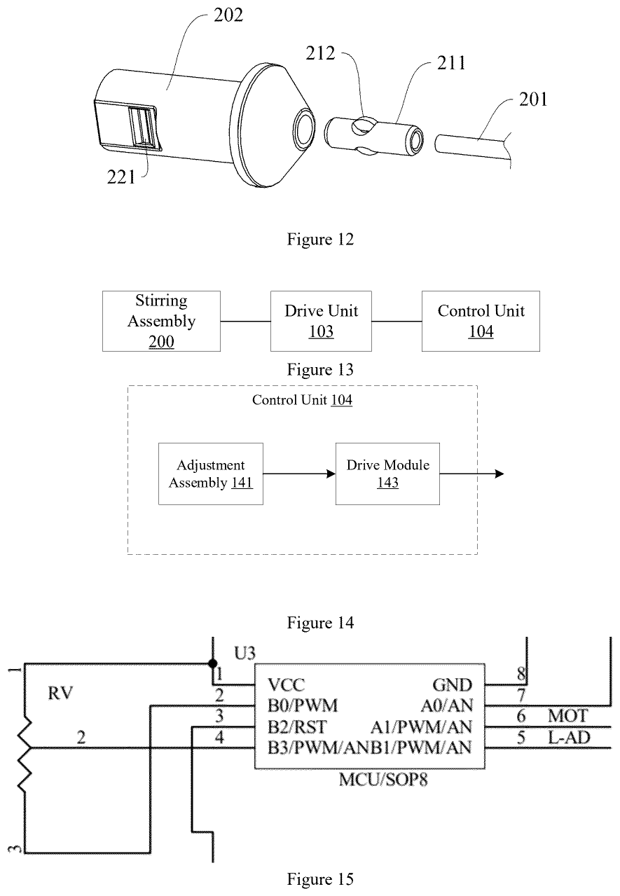

To firmly connect the stirring rod 201 to the adapter joint 202 and effectively transmit torque, please refer to FIG. 12, the end of the stirring rod 201 is inserted and fixed in an anti-rotation sleeve 211, and an outer peripheral surface of the anti-rotation sleeve 211 is provided with an anti-rotation protrusion 212, the anti-rotation sleeve 211 being inserted and fixed on the adapter joint 202. Between the stirring rod 201 and the anti-rotation sleeve 211, and between the anti-rotation sleeve 211 and the adapter joint 202, they may be fixedly connected by any means such as bonding, welding, interference fit, etc., and the anti-rotation protrusion 212 can effectively transmit torque with the adapter joint 202.

The milk frother host 100 in the present application can achieve at least two non-zero rotational speeds and start-stop control through a single operating member 102, and during speed adjustment, pressing down the operating member 102 can achieve acceleration, lifting the operating member 102 can achieve deceleration, and stopping rotation when the button is nearly fully released, enabling the operator to control the working state of the milk frother more intuitively and conveniently, with a relatively simple structure, capable of achieving continuous adjustment without obvious speed gear sense, conducive to improving the applicability and user experience of the milk frother.

### Embodiments of the Milk Frother Host in the Present Invention

The structure of the milk frother host may be the same as the structure of the milk frother host 100 in any of the above embodiments, which will not be repeated here.

### Embodiments of the Method for Controlling the Handheld Kitchen Stirring Rod in the Present Invention

A method for controlling a handheld kitchen stirring rod, providing an operating member, the operating member being configured to change an electrical parameter of an adjustment assembly in a control unit during movement; the control unit controlling a rotational speed of a drive unit based on a change in the electrical parameter; the operating member comprising, on a movement stroke of the operating member, a first stroke segment corresponding to stopping of the drive unit and a second stroke segment corresponding to at least two non-zero rotational speeds of the drive unit;
a proportion of the first stroke segment to a sum of the first stroke segment and the second stroke segment is greater than or equal to 5%.

It can be understood that in some embodiments, when the operating member moves to the end of the first stroke segment, the drive unit starts, and when the operating member moves between the second stroke segment, the electrical parameter of the adjustment assembly changes, causing a change in the rotational speed of the drive unit. The rotational speed value of the drive unit may correspond one-to-one with the electrical parameter value of the adjustment assembly, or may be a one-to-many relationship, for example, within a certain range of electrical parameter values of the adjustment assembly, the control unit controls the drive unit to execute the same rotational speed. In some embodiments, a third stroke segment may also be provided, and when the operating member retracts from the second stroke segment and moves to the third stroke segment, the control unit controls the drive unit to stop rotating, the starting point of the third stroke segment and the end point of the second stroke segment may be the same position or different positions. It can be understood that the

starting point of the third stroke segment is the first position reached by the operating member retracting from the second stroke segment, and the end point of the third stroke segment may be the starting point of the first stroke segment.

The drive unit, control unit, and operating member may be corresponding structures in any embodiment of the above handheld kitchen stirring rod, which will not be repeated here, and the control unit can control the drive unit to achieve start-stop control and speed adjustment in the manner described above.

The above uses specific examples to illustrate the present invention, which is only used to help understand the present invention and is not intended to limit the present invention. For those skilled in the art to which the present invention pertains, several simple deductions, modifications, or substitutions may also be made based on the ideas of the present invention.

1. A milk frother host, wherein comprising:
a host housing for holding;
a drive unit, the drive unit being defined on the host housing, the drive unit being configured to drive a stirring assembly connected to the milk frother host to rotate;
a control unit configured to control a rotational speed of the drive unit, the control unit comprising an adjustment assembly;
and wherein an operating member, the operating member being defined on the host housing, the operating member changing an electrical parameter of the adjustment assembly during movement, the operating member comprising, on a movement stroke of the operating member, a first stroke segment corresponding to stopping of the drive unit and a second stroke segment corresponding to at least two non-zero rotational speeds of the drive unit;
a proportion of the first stroke segment to a sum of the first stroke segment and the second stroke segment is greater than or equal to 5%.

2. The milk frother host according to claim 1, wherein the adjustment assembly comprises an adjustment element and an adjustment portion, the adjustment portion being configured to change an electrical parameter of the adjustment element during movement; the control unit being configured to control a rotational state of the drive unit based on a change in the electrical parameter.

3. The milk frother host according to claim 2, wherein the operating member is movably defined along a straight line on the host housing, a transmission structure being provided between the operating member and the adjustment portion, the transmission structure being configured to drive the adjustment portion to move when the operating member moves.

4. The milk frother host according to claim 3, wherein the transmission structure comprises a movable member, the milk frother host comprising a guide seat defined inside the host housing, the movable member being movably defined along a straight line on the guide seat, with a movement direction parallel to a movement direction of the operating member; an outer peripheral surface of the movable member being provided with a clamping groove, the clamping groove having a first groove side wall and a second groove side wall spaced apart along the movement direction of the movable member, the adjustment portion being embedded in the clamping groove to reciprocate with the movable member.

5. The milk frother host according to claim 4, wherein a side surface of the movable member is provided with a sliding groove extending along the movement direction of the movable member, the guide seat being provided with a protruding portion embedded in the sliding groove, the protruding portion being configured to restrict rotation of the movable member.

6. The milk frother host according to claim 4, wherein the operating member is a button, the host housing having a first end and a second end, an arrangement direction of the first end and the second end being parallel to a rotational axis of the drive unit, the first end being configured to connect to the stirring assembly, the button being defined at the second end, a pressing direction of the button being parallel to the rotational axis of the drive unit.

7. The milk frother host according to any one of claim 2, wherein the adjustment assembly is a variable resistance element configured to produce a resistance change when the adjustment portion moves.

8. A handheld kitchen stirring rod, wherein comprising:
a host housing for holding;
a drive unit, the drive unit being defined on the host housing, the drive unit being configured to drive a stirring assembly connected to the handheld kitchen stirring rod to rotate;
a control unit configured to control a rotational speed of the drive unit, the control unit comprising an adjustment assembly;
and wherein an operating member, the operating member being defined on the host housing, the operating member changing an electrical parameter of the adjustment assembly during movement, the operating member comprising, on a movement stroke of the operating member, a first stroke segment corresponding to stopping of the drive unit and a second stroke segment corresponding to at least two non-zero rotational speeds of the drive unit; a proportion of the first stroke segment to a sum of the first stroke segment and the second stroke segment is greater than or equal to 5%.

9. The handheld kitchen stirring rod according to claim 8, wherein the stirring assembly comprises a detachable first stirring assembly and a second stirring assembly, functional units on the first stirring assembly and the second stirring assembly being different.

10. A handheld kitchen stirring rod host, wherein comprising:
a host housing for holding;
an operating member defined on the host housing;
a drive unit, the drive unit being defined on the host housing, the drive unit being configured to drive a stirring assembly connected to the handheld kitchen stirring rod host to rotate;
and wherein a control unit, the control unit comprising an adjustment assembly, the operating member being connected to the adjustment assembly and configured to change an electrical parameter of the adjustment assembly, the control unit being configured to control starting and stopping of the drive unit and achieve at least two non-zero rotational speeds based on a change in the electrical parameter.

11. The handheld kitchen stirring rod host according to claim 10, wherein the adjustment assembly comprises an adjustment element and an adjustment portion, the adjustment portion being configured to change an electrical parameter of the adjustment element during movement; the control unit being configured to control a rotational state of the drive unit based on a change in the electrical parameter.

12. The handheld kitchen stirring rod host according to claim 11, wherein the operating member is movably defined along a straight line on the host housing, a transmission structure being provided between the operating member and the adjustment portion, the transmission structure being configured to drive the adjustment portion to move when the operating member moves.

13. The handheld kitchen stirring rod host according to claim 12, wherein the transmission structure comprises a movable member, the handheld kitchen stirring rod host comprising a guide seat defined inside the host housing, the movable member being movably defined along a straight line on the guide seat, with a movement direction parallel to a movement direction of the operating member; an outer peripheral surface of the movable member being provided with a clamping groove, the clamping groove having a first groove side wall and a second groove side wall spaced apart along the movement direction of the movable member, the adjustment portion being embedded in the clamping groove to reciprocate with the movable member.

14. The handheld kitchen stirring rod host according to claim 13, wherein the guide seat comprises a main body portion and a guide portion protruding from the main body portion, the guide portion being provided with a guide space for movable assembly of the movable member, one side of the guide portion being provided with a clamping interface communicating with the guide space, the clamping interface allowing the movable member to snap into the guide space and be removed from the guide space along a direction perpendicular to the movement direction of the movable member.

15. The handheld kitchen stirring rod host according to claim 14, wherein an outer peripheral surface of the movable member is provided with two ribs extending circumferentially around the movable member, the clamping groove being formed by an interval between the ribs; the ribs being configured to abut against the guide portion along the movement direction of the movable member to prevent the movable member from escaping the guide space.

16. The handheld kitchen stirring rod host according to claim 14, wherein the movable member is provided with a spring assembly hole, the transmission structure comprising a return spring, the return spring being configured to elastically deform when the operating member is pressed down, and drive the operating member to return when the operating member is released, the return spring being embedded in the spring assembly hole; the guide seat having an end surface spaced apart from the guide portion along the movement direction of the movable member, one end of the return spring away from the movable member abutting against the end surface.

17. The handheld kitchen stirring rod host according to any one of claim 13, wherein a side surface of the movable member is provided with a sliding groove extending along the movement direction of the movable member, the guide seat being provided with a protruding portion embedded in the sliding groove, the protruding portion being configured to restrict rotation of the movable member.

18. The handheld kitchen stirring rod host according to claim 10, wherein the operating member is a button, the host housing having a first end and a second end, an arrangement direction of the first end and the second end being parallel to a rotational axis of the drive unit, the first end being configured to connect to the stirring assembly, the button being defined at the second end, a pressing direction of the button being parallel to the rotational axis of the drive unit.

19. The handheld kitchen stirring rod host according to any one of claim 10, wherein the operating member changes an electrical parameter of the adjustment assembly during movement, the operating member comprising, on a movement stroke of the operating member, a first stroke segment corresponding to stopping of the drive unit and a second stroke segment corresponding to at least two non-zero rotational speeds of the drive unit; a proportion of the first stroke segment to a sum of the first stroke segment and the second stroke segment is greater than or equal to 5%.
